(19) United States
(12) Patent Application Publication
(10) Pub. No.: US 2026/0087406 A1
(43) Pub. Date: Mar. 26, 2026

(54) GUARDING MULTIMODAL ARTIFICIAL INTELLIGENCE SYSTEMS FROM MALICIOUS PROMPT ATTACKS

(71) Applicant: Microsoft Technology Licensing, LLC, Redmond, WA (US)

(72) Inventors: Reshmi GHOSH, Cambridge, MA (US); Vitor Rocha De CARVALHO, San Diego, CA (US); Robert SIM, Bellevue, WA (US); Emily LAWTON, Seattle, WA (US); Jack Wilson STOKES, North Bend, WA (US); Lukas WUTSCHITZ, London (GB); Ahmed Mohamed Gamal SALEM, Saarbrucken (DE); Xuefeng DU, Madison, WI (US)

(73) Assignee: Microsoft Technology Licensing, LLC, (US)

(21) Appl. No.: 18/988,604

(22) Filed: Dec. 19, 2024

Related U.S. Application Data
(60) Provisional application No. 63/698,995, filed on Sep. 25, 2024.
(60) Provisional application No. 63/701,415, filed on Sep. 30, 2024.

(51) Int. Cl. G06N 20/00

(52) U.S. Cl. CPC G06N 20/00

(57) ABSTRACT

A data processing system implements obtaining a plurality of unlabeled user prompts including an unknown mixture of malicious prompts and benign prompts; analyzing each unlabeled user prompt using a multimodal vision language model to obtain embeddings representing each unlabeled user prompt; analyzing the embeddings to determine representation of each unlabeled user prompt of the plurality of unlabeled user prompts in a latent space; determining a first region of the latent space associated with benign user prompts and a second region of the latent space associated with malicious user prompts; generating labeled training data by labeling each unlabeled user prompt of the plurality of unlabeled user prompts with an indication whether each unlabeled user prompt is a benign user prompt falling with the first region or a malicious user prompt falling within the second region; and training a prompt classifier using the labeled training data.

### BACKGROUND

Safeguarding vision language models (VLMs) against persistent threats of adversarial prompts has become a crucial yet challenging problem in safely deploying these multimodal foundation models in the wild, where the user prompts in the deployment time can naturally arise from a mixture distribution of both benign and malicious. Compared with text-only language models, modern VLMs process both text and images, making them particularly vulnerable to malicious prompts, which can target not only the textual input but also the visual component and thus allow attackers to manipulate both channels simultaneously. These malicious prompts can elicit harmful outputs or trigger unintended actions of VLM-integrated tools, such as but not limited to personal assistants, and thus place critical decision-making at risk. This risk underscores the need for VLMs to not only generate coherent responses but also detect potentially malicious prompts before producing outputs. Hence, there is a need for improved systems and methods that provide a technical solution for guarding artificial intelligence systems, including VLMs, from malicious prompt attacks, including but not limited to prompt injection attacks, cross prompt injection attacks, and jailbreak attacks.

### SUMMARY

An example data processing system according to the disclosure includes a processor and a memory storing executable instructions. The instructions when executed cause the processor alone or in combination with other processors to perform operations including obtaining a plurality of unlabeled user prompts, each unlabeled user prompt including a textual prompt element and a visual prompt element, the plurality of unlabeled user prompts including an unknown mixture of malicious prompts and benign prompts; analyzing each unlabeled user prompt of the plurality of unlabeled user prompts using a multimodal vision language model to obtain embeddings representing each unlabeled user prompt of the plurality of unlabeled user prompts; analyzing the embeddings to determine representation of each unlabeled user prompt of the plurality of unlabeled user prompts in a latent space; determining a first region of the latent space associated with benign user prompts and a second region of the latent space associated with malicious user prompts; generating labeled training data by labeling each unlabeled user prompt of the plurality of unlabeled user prompts with an indication whether each unlabeled user prompt is a benign user prompt falling with the first region of the latent space or a malicious user prompt falling within the second region of the latent space; training a prompt classifier using the labeled training data; and utilizing the prompt classifier to determine whether subsequently received prompts for the multimodal vision language model are benign or malicious.

An example method implemented in a data processing system includes obtaining a plurality of unlabeled user prompts, each unlabeled user prompt including a textual prompt element and a visual prompt element, the plurality of unlabeled user prompts including an unknown mixture of malicious prompts and benign prompts; analyzing each unlabeled user prompt of the plurality of unlabeled user prompts using a multimodal vision language model to obtain embeddings representing each unlabeled user prompt of the plurality of unlabeled user prompts; analyzing the embeddings to determine representation of each unlabeled user prompt of the plurality of unlabeled user prompts in a latent space; determining a first region of the latent space associated with benign user prompts and a second region of the latent space associated with malicious user prompts; generating labeled training data by labeling each unlabeled user prompt of the plurality of unlabeled user prompts with an indication whether each unlabeled user prompt is a benign user prompt falling with the first region of the latent space or a malicious user prompt falling within the second region of the latent space; training a prompt classifier using the labeled training data; and utilizing the prompt classifier to determine whether subsequently received prompts for the multimodal vision language model are benign or malicious.

An example data processing system according to the disclosure includes a processor and a memory storing executable instructions. The instructions when executed cause the processor alone or in combination with other processors to perform operations including obtaining a user prompt from an application, the user prompt comprising a textual prompt element and a visual prompt element for a multimodal vision language model; analyzing the user prompt with a prompt classifier to obtain a determination whether the user prompt is malicious or benign, the prompt classifier being trained using unlabeled sample user prompts that include both benign and malicious prompts that have been analyzed to determine a maliciousness estimation score for each sample user prompt; and preventing the user prompt from being provided as an input to the multimodal vision language model in response to the prompt classifier determining that the user prompt is malicious.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1A is a diagram of an example process for detecting and preventing prompt injection attacked according to the techniques provided herein.

FIG. 1B is a diagram of an example implementation of a prompt injection prevention framework according to the techniques provided herein.

FIG. 2A is a diagram of a prompt classifier training pipeline that can be used to train the prompt classifier shown in FIG. 1B.

FIG. 2B is a diagram providing a visualization of representation of benign and malicious samples and their projection onto the first principal component.

FIG. 2C shows an example implementation of the prompt classifier shown in FIGS. 1B and 2A.

FIG. 3 is a diagram of an example computing environment in which the techniques for safeguarding vision language models from prompt injection attacks described herein are implemented.

FIG. 4 is a diagram showing examples of benign and malicious prompts according to the techniques provided herein.

FIG. 5A is a flow chart of an example process for training a prompt classifier according to the techniques disclosed herein.

FIG. 5B is a flow chart of an example process for detecting prompt injection according to the techniques disclosed herein.

FIG. 6 is a block diagram showing an example software architecture, various portions of which may be used in conjunction with various hardware architectures herein described, which may implement any of the described features.

FIG. 7 is a block diagram showing components of an example machine configured to read instructions from a machine-readable medium and perform any of the features described herein.

### DETAILED DESCRIPTION

Systems and methods for guarding against malicious prompt attacks, including but not limited to prompt injection attacks, cross prompt injection attacks, jailbreak attacks and/or other types of malicious prompt attacks on generative AI systems are provided herein. These techniques provide a technical solution for detecting prompt injection attacks for multimodal models, such as but not limited to vision language models (VLMs). These techniques can be used to detect direct prompt injection attacks and/or indirect prompt injection attacks. Direct prompt injection attacks are attacks on a generative model in which malicious inputs to a generative model are disguised as legitimate user inputs. For instance, a malicious user may include antagonistic instructions in a textual prompt to the generative model or include antagonistic instructions to the generative model in an image provided as an input to a multimodal generative model. Indirect prompt injection attacks are another type of prompt injection attack in which malicious inputs are disguised in third-party data. In such indirect prompt injection attacks, the user who generated the textual prompt to the generative model may not be aware that antagonistic data has been introduced into the third-party data that is provided as an input to the generative model. For instance, retrieval-augmented generation (RAG) frameworks can utilize third-party data as an input to the generative model to enhance the output generated by the generative model. Malicious actors can introduce antagonistic data into this third-party data which is then provided as an input to the generative model.

The techniques herein provide a prompt injection prevention framework that includes a prompt classifier that analyzes prompts before the prompts are provided as an input to the generative model to assess whether the prompt is associated with a prompt injection attack. The prompt classifier analyzes the prompt and generates a maliciousness estimation score that differentiates between malicious and benign prompts and outputs an indication whether or not the prompt is predicted to be malicious based on this maliciousness estimation score. The prompt classifier can exploit the generative model's latent representations of input prompts to identify features in these latent representations indicative of a prompt being malicious or benign. The prompt classifier determines the maliciousness estimation score through decomposition in the representation space of the latent representations, where the top principal components as determined from a sample of representative unlabeled data define the latent subspace for maliciousness estimation. The prompt classifier can compute the maliciousness estimation score as the norm of the embedding of the prompt projected onto the latent subspace defined by the top principal components, which provides better separation for benign and malicious prompts. In other implementations, the prompt classifier can compute the maliciousness estimation score as the norm of the residual of the embedding after projection onto the latent subspace defined by the top principal components, where the embedding residual is defined as the difference between the embedding as its subspace projection. A technical benefit of approach of determining the maliciousness estimation scores is that the maliciousness estimation score provides a clear mathematical interpretation of the predicted maliciousness of the prompt that can be utilized to quickly identify potentially antagonistic prompts and to prevent these prompts from being provided as an input to the generative model. These and other technical benefits of the techniques disclosed herein will be evident from the discussion of the example implementations that follow.

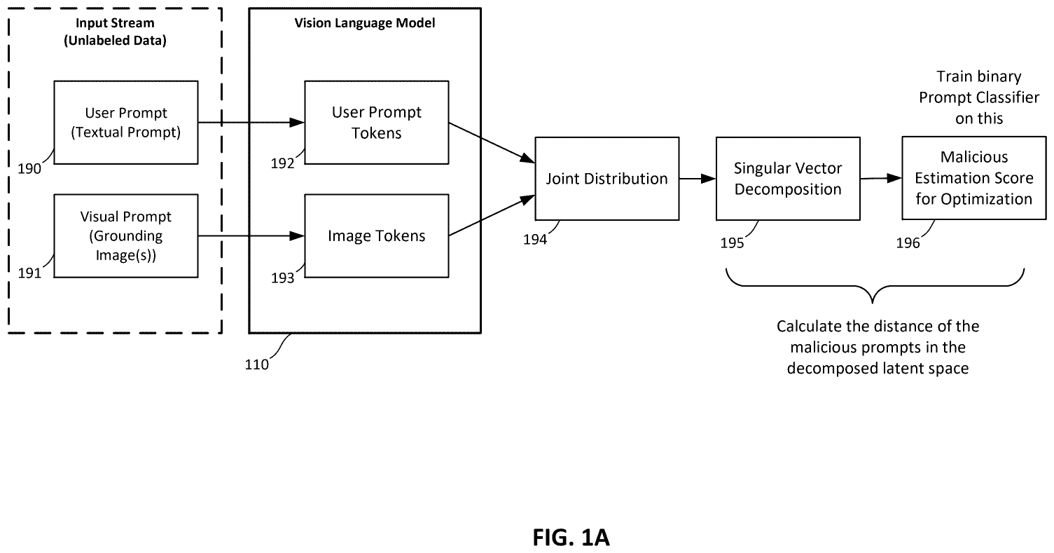

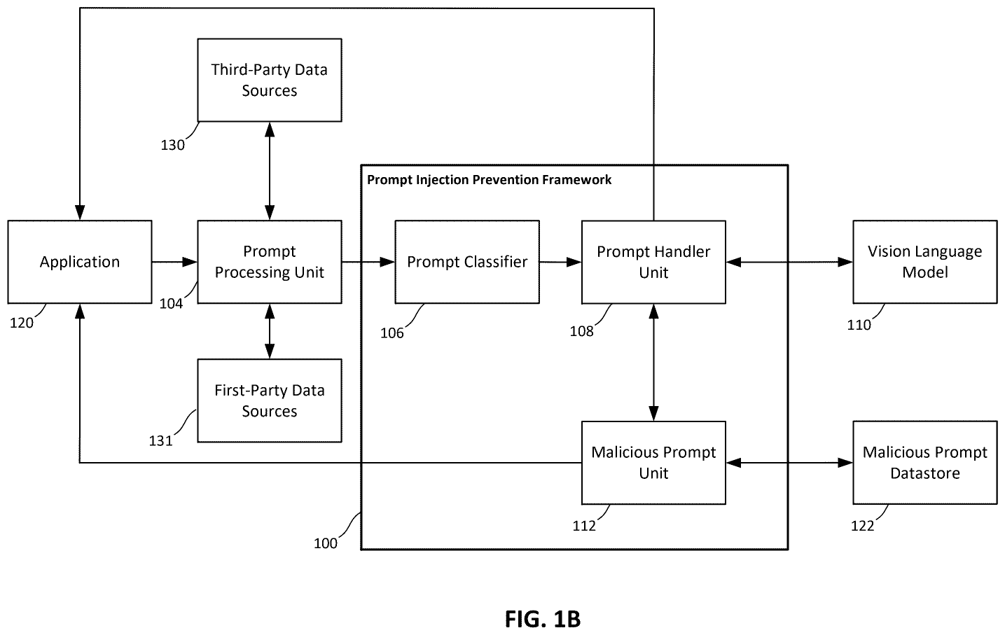

FIG. 1A is a diagram of an example process for detecting and preventing prompt injection attacks according to the techniques provided herein. The techniques herein rely on identifying and/or learning the distribution of malicious prompts in unlabeled user prompt data by projecting the user prompts into a latent space or subspace representing embedding generated by the vision language model 110 from the user prompt. Other implementations include partially labeled user prompt data that includes a portion of known malicious user prompts and/or a portion of known benign prompts and learning the distribution of malicious prompts in the partially labeled user prompts data. The embeddings may represent a textual user prompt 190 and/or a visual prompt 191 comprising one or more images that provide context or grounding to the vision language model 110. The process of automatically detecting malicious user prompts in a vision language model system includes the following operations.

For any vision language model system, there are two inputs to the vision language model: a user prompt element (the textual user prompt 190) and a visual prompt element (visual prompt 191). The user prompt element includes a set of instructions to the vision language model 110 to execute one or more tasks. The user prompt element is always benign in indirect prompt injection attacks but are malicious in direct prompt injection attacks. The visual prompt element includes one or more images that are provided as grounding data for the vision language model 110 to perform the one or more tasks specified in the user prompt. The one or more images may be provided by the user or may be automatically retrieved as part of a reasoning engine. The one or more images are often considered to be relevant to the user prompt.

The textual user prompt 190, denoted by x^{t}, and images retrieved for grounding data, denoted by x^{v}, are transformed into user tokens 192 and image tokens 193 respectively by the tokenizer of the vision language model 110. Together the user prompt tokens x^{t} and image tokens x^{v} constitute the unlabeled data [symbol] _{unlabeled}. In some instances, the user executing tasks using the vision language model 110 may input benign prompts to describe a task to be performed and a malicious prompt is embedded in the image as noise (similar to steganography). Other combinations of malicious prompts may also be supported as discussed in the examples which follow. The mixture of malicious (or contaminated) and benign data as part of the input stream can be denoted as: [symbol] _{unlabeled}, Where [symbol] _{unlabeled}=π [symbol] _{malicious}+(1+π) [symbol] _{benign}, where where [symbol] _{malicious} denotes the distribution of malicious data and [symbol] _{benign} denotes the distribution of benign data in the prompts, and π denotes the mixing ratio of the malicious and benign data in a set of unlabeled input prompts.

Once the user prompt, denoted by x^{t}, and images retrieved for grounding data, denoted by x^{v}, are tokenized using the tokenizer of the vision language model 110, the vision language model 110 then transforms the combined user prompt and image tokens into a vector in the model's latent embedding space, constituting a joint distribution. A singular value decomposition 195 is performed on the vectorized input stream, which is a matrix of embedding values. The singular value decomposition 195 is used to calculate an automated maliciousness estimation score based on the vectors resulting from transforming the tokenized inputs to estimate whether the input stream is malicious or benign. Decomposition enables normalization of the embeddings from the mean (center of the embedding space) and then calculating distance of the user prompt x^{t} and images x^{v} in the latent space to determine whether the distance exceeds a distance threshold, which is indicative of the images being malicious, as the user prompt can always thought to be benign in indirect prompt injection scenarios. Otherwise, if the distance does not exceed the threshold, the prompt is benign. The framework provided herein introduces an automated maliciousness estimation score 196 that enables the differentiation between benign and malicious samples within the unlabeled data. As discussed in the examples below, the maliciousness estimation score can be used to facilitate the training of the prompt classifier.

FIG. 1B is a diagram of an example implementation of a prompt injection prevention framework 100 according to the techniques provided herein. The prompt injection prevention framework can receive prompts to a generative model, such as but not limited to the vision language model 110 shown in FIGS. 1A and 1B. The vision language model 110 is a multimodal generative artificial intelligence model that can receive prompts that include both textual and visual inputs. The vision language model 110 can provide an application programming interface (API) or other means or accessing the embeddings determined by the model. The vision language model 110 can be implemented by a Large Language and Vision Assistant (LLaVA) model, a Phi 3, 4, or 5 vision model, a multimodal Pixtral model such as but not limited to the Pixtral 12B model, or other multimodal language models that provide access to their embeddings. The vision language model 110 can be implemented by other types of generative models that provide access to their embedding. Prompts to the vision language model 110 can be received from the application 120. The prompt can include a textual prompt instructing the vision language model 110 to generate specified content and one or more images that provide context to the vision language model 110 when performing the requested actions. The textual prompt may be input, at least in part, by a user of the application 120. The user may also select an image or images to be included with the textual prompt. The prompt can also be constructed, at least in part, by the prompt processing unit 104, which can format the text of the user prompt into a format expected by the vision language model 110.

The prompt processing unit 104 can also support a retrieval framework in which the user prompt is supplemented by content from one or more first party data sources 131 and/or one or more third-party data sources 130. First-party data sources, as used herein, refers to data sources within an organization or service, and third-party data sources, as used herein, refers to data sources provided from sources outside of the organization or service. For instance, the prompt processing unit 104 analyzes the prompt received from the application 120 to determine that additional content is required to fulfill the instructions included in the prompt, generates a query or queries to the one or more first party data sources 131 and/or the one or more third-party data sources 130 to obtain additional information to fulfill the instructions, and constructs a prompt to be submitted to the vision language model 110 based on this additional information. The one or more third-party data sources 130 can include one or more data sources available via the Internet. The additional information can include textual content, image content, web pages, videos, audio content, and/or other types of content that the vision language model 110 is capable of processing as an input. The prompt, including any textual and/or non-textual components, output by the prompt processing unit 104 is provided as an input to the prompt injection prevention framework 100 for analysis.

The prompt classifier 106 of the prompt injection prevention framework 100 analyzes prompts to determine the maliciousness estimation score for the prompts. The prompt classifier 106 determines the maliciousness estimation score using various means. One approach that can be implemented by the prompt classifier 106 is discussed in the examples which follow. The prompt classifier 106 determines whether the maliciousness estimation score satisfies a predetermined threshold in some implementations and outputs a binary indication whether the prompt was determined to be malicious. The prompt handler unit 108 receives the prompt and the indication whether the prompt was determined to be malicious from the prompt classifier 106. In response to the prompt classifier 106 determining that the prompt is not malicious, the prompt handler unit 108 provides the prompt to the vision language model 110 as an input. As indicated above, the prompt may include a text prompt portion as well as one or more image and/or other content to be analyzed by the vision language model 110. The prompt handler unit 108 receives the content generated by the vision language model 110 in response to the prompt and provides the content to the application 120. In response to the prompt classifier 106 determining that the prompt is malicious, the prompt handler unit 108 provides the prompt to the malicious prompt unit 112 rather than providing the prompt to the vision language model 110. The malicious prompt unit 112 can take various actions in response to the malicious prompt. The malicious prompt unit 112 may notify the application 120 that the prompt cannot be executed. The malicious prompt unit 112 may also store the prompt in a malicious prompt datastore 122. The malicious prompt datastore 122 is a persistent datastore that enables an administrator of the vision language model 110 to analyze the prompts that were determined to be malicious by the prompt classifier 106. The malicious prompt datastore 122 can store the text prompt, any images and/or other content provided by the user, and/or other content obtained from the one or more first party data sources 131 and/or the one or more third-party data sources 130 in the malicious prompt datastore 122 for later analysis. The malicious prompt unit 112 may also perform other actions on the malicious prompts, such as generating reports that summarize the prompts that have been received that have been determined to be malicious.

The prompt classifier 106 can determine the maliciousness estimation score as follows. The prompts received from the application 120 can be assumed to receive a mix of benign [symbol] _{benign} and malicious prompts [symbol] _{malicious}. Leveraging unlabeled data in this context is non-trivial due to the absence of explicit labels indicating whether a sample belongs to the benign or malicious category. The prompt classifier 106 assigns a determination of the category to a prompt received from the application 120, using the techniques which follow.

The vision language model 110 can be represented as an L-layer VLM, which takes a sequence of n textual tokens

$${x}_{prompt}^{t} = \{ {x}_{1}^{t} , … , {x}_{n}^{t} \}$$

and m visual tokens

$${x}_{prompt}^{v} = \{ {x}_{1}^{v} , … , {x}_{m}^{v} \}$$

to generate an output x={xₙ₊ₘ₊₁, . . . , xₙ₊ₘ₊ₒ} in an autoregressive manner. Each output text token xᵢ, i∈{n+m+1, . . . , n+m+o} is sampled from a distribution over a model vocabulary V, conditioned on the prefix {x₁, . . . , xᵢ₋₁}:

$${x}_{i} = arg {max}_{x ∈ V} P ( x \vert \{ {x}_{1} , … , {x}_{1 i - 1} \} ) , \qquad ( 1 )$$

and the probability P is calculated as:

$$P ( x \vert \{ {x}_{1} , … , {x}_{1 i - 1} \} ) = softmax ( {wf}_{L} ( x ) + b ) , \qquad ( 2 )$$

where f_{L}(x)∈ [symbol] ^{d} denotes the representation at the L-th layer of the VLM for token x, and w and b are the weight and bias parameters at the final output layer.

The malicious prompt detection performed by the prompt classifier 106 can be expressed as follows. [symbol] _{malicious} denotes the joint distribution over the visual and textual prompts where the VLM generations are malicious, which is referred to herein as the malicious distribution. For any user-provided prompt

$$( {x}_{prompt}^{v} , {x}_{prompt}^{t} ) ∈ {X}_{prompt} ,$$

the goal of the malicious detection is to learn a binary predictor G: Xₚᵣₒₘₚₜ→{0, 1}, such that

$$G ( {x}_{prompt}^{v} , {x}_{prompt}^{t} ) = \{ \begin{matrix}1 , & ( {x}_{prompt}^{v} , {x}_{prompt}^{t} ) ∼ {ℙ}_{malicious} \\ 0 , & otherwise\end{matrix} \qquad ( 3 )$$

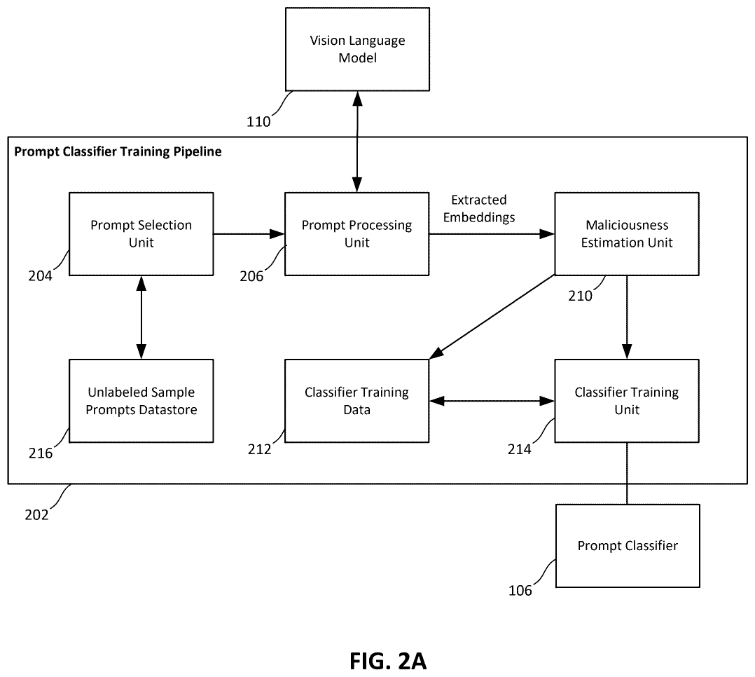

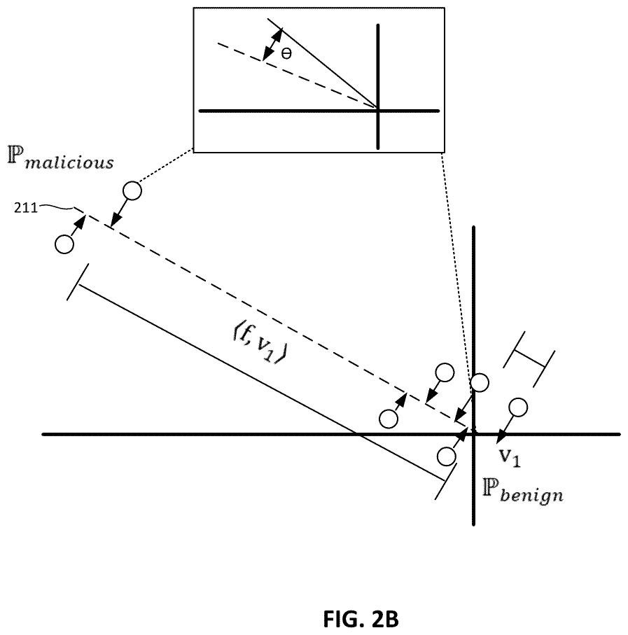

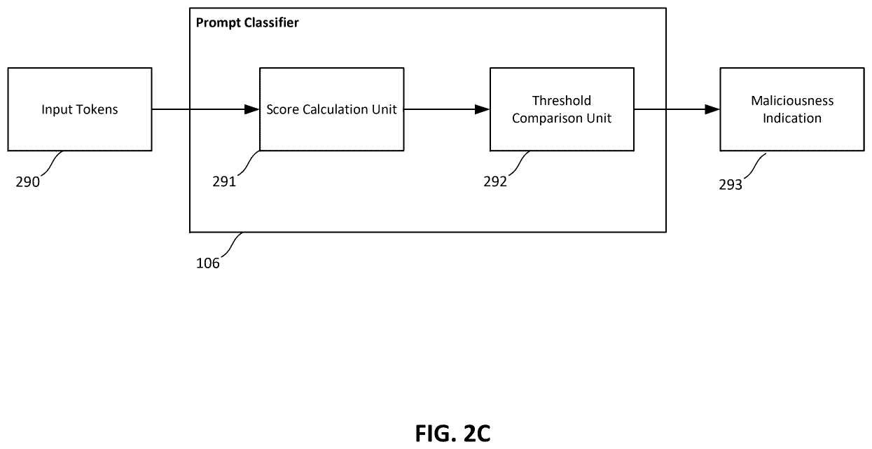

FIG. 2A is a diagram of a prompt classifier training pipeline 202 that can be used to train the prompt classifier 106. The prompt classifier 106 is likely to encounter an unlabeled prompt distribution, which can be can be expressed as [symbol] _{unlabeled}=π [symbol] _{malicious}+(1−π) [symbol] _{benign}, where π∈(0,1). The value of π is unknown. Where π=0, there are no malicious prompts included in the unlabeled data. However, in practice the value of π is not likely to be zero, and a small subset of the user prompts encountered by the prompt classifier 106 will be malicious. The prompt classifier training pipeline 202 trains the prompt classifier to detect such malicious prompts. The prompts may arise from user interactions within the application 120. For instance, users may input a vast array of textual and visual user queries to be processed by the vision language model 110. These prompts may be collected, with user content, to populate the unlabeled sample prompts datastore 216. The unlabeled sample prompts datastore 216 is a persistent storage that can be used to store this sample data to be used for training the prompt classifier 106. The prompt selection unit 204 can sample an empirical dataset from the unlabeled sample prompts datastore 216. The dataset can be represented as

$$𝒟 = \{ ( {χ}_{prompt}^{v , 1} , {x}_{prompt}^{t , 1} ) , … , ( {x}_{prompt}^{v , N} , {x}_{p r ompt}^{t , N} ) \} ,$$

where the dataset is sampled independently and identically distributed (i.i.d.) from the mixture distribution [symbol] _{unlabeled}, where N is the number of samples. The membership of the benign and malicious samples included in the dataset [symbol] is not known. The prompt classifier training pipeline 202 first determines a representation of the maliciousness in latent subspace before training the prompt classifier 106 based on this representation as discussed below.

The prompt selection unit 204 samples the dataset [symbol] from the unlabeled sample prompts datastore 216. Each of the samples is a prompt that includes a textual prompt and an image component. The prompt processing unit 206 submits each of the prompts to the vision language model 110 to extract embeddings from the vision language model 110 as well as the text and vision tokens for each of the samples in the dataset [symbol] . Let F= [symbol] ^{N×d} denote the matrix of embeddings extracted from the vision language model 110 for the samples in dataset [symbol] , where each row represents the embedding vector

$${f}_{i}^{T}$$

of a data sample

$$( {x}_{prompt}^{v , i} , {x}_{prompt}^{t , i} ) .$$

To identify the latent subspace using principal component analysis, the maliciousness estimation unit 210 performs singular value decomposition on the extracted representations:

$${f}_{i} := {f}_{i} - μ \qquad ( 5 )$$

$$F = U \sum {V}^{T} ,$$

where μ∈ [symbol] ^{d} is the average embeddings across all N samples and is used to center the embedding matrix. The singular value decomposition is a factorization in which the columns of U and V are left and right principal components that form an orthogonal basis. The singular value decomposition finds the orthogonal axes that best capture variations in the data and can be used to reduce the dimensionality of the embeddings. In principle, the decomposition can be applied to any layer of the vision language model 110 representations. A technical benefit of this approach is that the decomposition enables the discovery of the most important spanning direction of the subspace for the set of points in D. Other implementations can utilize other methods to compute the basis functions, including but not limited to autoencoders and variational autoencoders.

The maliciousness estimation unit 210 estimates the maliciousness of user prompts using the data derived above. To illustrate how the maliciousness estimation unit 210 estimates the maliciousness of the prompts, a simplified case in which the subspace is one-dimensional is first considered. In this example implementation, the maliciousness estimation unit 210 uses linear regression to determine a best-fitting line through the origin for a set of points {fᵢ|1≤i≤N} which involves minimizing a sum of the squared perpendicular distances from the points to the line as shown in FIG. 2B. FIG. 2B is a diagram providing a visualization of representation of benign and malicious samples and their projection onto the top principal component v₁ represented by the dashed line 211. Geometrically, identifying the first principal component v₁ is equivalent to maximizing the total distance from the projected embeddings (onto the direction of v₁) to the origin, summed over all points in [symbol] :

$${v}_{1} = {arg max}_{{‖ v ‖}_{2} = 1 , v ∈ {ℝ}^{d}} {\sum }_{i = 1}^{N} {〈 {f}_{i} , v 〉}^{2} , \qquad ( 6 )$$

where [symbol] ·,· [symbol] denotes the dot product operator. As shown in FIG. 2B, malicious data samples tend to exhibit anomalous behavior compared to benign user prompts, often positioning themselves farther away from the center. This reflects the practical scenarios in which a minority of the generations are malicious, while a majority of the generations are benign. To determine membership, the maliciousness estimation score is defined as [symbol] = [symbol] fᵢ,v [symbol] , which measures the norm of fᵢ projected onto the first principal component. A technical benefit of this approach is that membership to the benign or malicious prompt can be assigned to each of the unlabeled user prompts based on the relative magnitude of the maliciousness estimation score. Another technical benefit of the maliciousness estimation score is that the score provides a straightforward mathematical interpretation of maliciousness that can be easily implemented in practical applications. Furthermore, the score can be generalized to utilize the subspace of k orthogonal principal components as follows:

$${i}_{} = \frac{1}{k} {\sum }_{j = 1}^{k} {λ}_{j} \cdot {〈 {f}_{i} , {v}_{j} 〉}^{2} , \qquad ( 7 )$$

where vⱼ is the j^{th} column of V, and λⱼ is the corresponding singular value. Here, k represents the number of spanning directions in the subspace. The underlying intuition is that malicious samples can effectively be captured by a small subspace, thereby distinguishing them from benign samples.

In some implementations, the maliciousness estimation score is computed as the norm of the residual of the embedding after projection onto the latent subspace defined by the top principal components, where the embedding residual is defined as the difference between the embedding as its subspace projection. Formally, if X is the embedding and P is the projection subspace represented by the top principal components, the residual r is defined as

$$r = X - {PXP}^{′}$$

where the score is the Euclidean norm ∥r∥.

The maliciousness estimation unit 210 can output the input textual prompt and image tokens, embeddings, and an indication whether the prompts are malicious or benign to the classifier training data 212. The classifier training unit 214 can then use this data to train the prompt classifier 106. A technical benefit of this approach is that labeled datasets are that include both benign and malicious samples are typically of limited availability. Constructing such labeled datasets for training the prompt classifier 106 would typically necessitate human annotators to meticulously evaluate a large volume of prompts. This manual approach is extremely labor intensive and expensive. Furthermore, ensuring the quality and consistency of the labeled data would require ongoing annotation efforts and rigorous quality controls, as generative models continually advance, and user prompts grow increasingly diverse. The prompt classifier training pipeline 202 provides a technical solution to these problems by providing an automated solution for leveraging unlabeled user prompts, such as those included in the unlabeled sample prompts datastore 216. As discussed above, these user prompts have naturally arisen from user interactions with the vision language model 110. User privacy concerns can be met by obtaining user permission to utilize the user prompts and/or through privacy preserving techniques that can anonymize the user prompts.

The classifier training unit 214 trains the prompt classifier 106. The classifier training unit 214 trains the prompt classifier 106, represented as h_{θ} herein, with a training dataset that includes a set of malicious prompts, represented as

$$= \{ ( {x}_{prompt}^{v , i} , {x}_{prompt}^{t , i} ) ∈ 𝒟 : {i}_{} > T \} ,$$

and a set of benign prompts, represented as

$$ℬ = \{ ( {x}_{prompt}^{v , i} , {x}_{prompt}^{t , i} ) ∈ 𝒟 : {i}_{} \leq T \} ,$$

from the classifier training data 212. The prompt classifier h_{θ} is designed to optimize the distinction between the benign and malicious datasets. In particular, the training objective can be expressed as minimizing the following risk, where samples from [symbol] should be classified as positive, and samples from [symbol] should be classified as negative:

$${, ℬ}_{} ( {h}_{θ} ) = ( {h}_{θ} ) + {ℒ}_{ℬ}^{-} ( {h}_{θ} ) = {𝔼}_{( {x}_{prompt}^{v , i} , {x}_{prompt}^{t , i} ) ∈ ℳ} \{ {h}_{θ} ( {x}_{prompt}^{v , i} , {x}_{prompt}^{t , i} ) \leq 0 \} + {𝔼}_{( {x}_{prompt}^{v , i} , {x}_{prompt}^{t , i} ) ∈ ℬ} \{ {h}_{θ} ( {x}_{prompt}^{v , i} , {x}_{prompt}^{t , i} ) > 0 \} \qquad ( 8 )$$

In some implementations, rather than directly minimize a 0/1 loss, the classifier training unit 214 instead minimizes a binary sigmoid loss. A technical benefit of this approach is that it provides a smooth and computationally feasible alternative to directly minimizing the 0/1 loss. At the test stage (also referred to the inference stage herein), the trained prompt classifier is utilized for malicious prompt detection.

$$( {\tilde{x}}_{prompt}^{v} , {\tilde{x}}_{prompt}^{t} )$$

represents the tokens used at the inference or test stage, while

$$( {x}_{prompt}^{v , i} , {x}_{prompt}^{t , i} )$$

discussed above represent the tokens used during the training stage. The trained prompt classifier performs malicious prompt detection using a malicious scoring function

$$S ( {\tilde{x}}_{prompt}^{v} , {\tilde{x}}_{prompt}^{t} ) = \frac{{e}^{{h}_{θ ( {\tilde{x}}_{prompt}^{v} , {\tilde{x}}_{prompt}^{t} )}}}{1 + {e}^{{h}_{θ ( {\tilde{x}}_{prompt}^{v} , {\tilde{x}}_{prompt}^{t} )}}} ,$$

$$where ( {\tilde{x}}_{prompt}^{v} , {\tilde{x}}_{prompt}^{t} ) denotes {h}_{θ} ( {x}_{prompt}^{v , i} , {x}_{prompt}^{t , i} ) ,$$

the test visual and textual prompt. Based on this score, the prompt classifier 106 classifies a user prompt received as an input as malicious if

$${G}_{τ} ( {\tilde{x}}_{prompt}^{v} , {\tilde{x}}_{prompt}^{t} ) = \{ S ( {\tilde{x}}_{prompt}^{v} , {\tilde{x}}_{prompt}^{t} ) \geq τ \} ,$$

with 1 indicating a malicious prompt and 0 indicating a benign prompt.

While the example implementation discussed above trains the prompt classifier 106 on the raw embeddings from the vision language model 110, other implementations can train the prompt classifier 106 on the k-dimensional subspace projection rather than the embeddings.

FIG. 2C shows an example implementation of the prompt classifier 106 according to the techniques discussed above. The input tokens 290 denote the text and visual tokens,

$$( {\tilde{x}}_{prompt}^{v} , {\tilde{x}}_{prompt}^{t} ) ,$$

derived from a user prompt entered via the application 120. The score calculation unit 291 determines the maliciousness estimation score using the malicious scoring function S discussed above. The maliciousness estimation score is provided as an input to the threshold comparison unit, which compares the maliciousness estimation score to the threshold t. In the implementation shown in the preceding example, if the maliciousness estimation score is greater than or equal to the threshold t, the user prompt is determined to be malicious, and the threshold comparison unit outputs a maliciousness indication 293 having a value of 1, which indicates that the prompt has been determined to be malicious. Otherwise, the threshold comparison unit 292 outputs a maliciousness indication 293 having a value of 0, which indicates that the prompt was determined to be benign.

In some embodiments of the classifier training pipeline, rather than relying on unlabeled data comprising an unknown percentage of benign data and an unknown percentage of malicious data, the data may include at least a portion of known malicious data. The known malicious data may be discovered or created by known attacks, and these samples can be used to improve the training of the prompt classifier 106. The data in this scenario is referred to as partially labeled data, and this data can be used instead of the unlabeled data from the unlabeled sample prompts datastore 216. The partially labeled data can be denoted as follows:

$${ℙ}_{PartiallyLabled} = {π}_{1} {ℙ}_{malicious , known} + {π}_{2} {ℙ}_{malicious , unknown} + ( 1 - {π}_{1} - {π}_{2} ) {ℙ}_{benign , unknown}$$

where [symbol] _{malicious,known} represents the known malicious samples, [symbol] _{malicious,unknown} represents the unknown malicious samples, [symbol] _{benign,unknown} represents unknown benign samples, π₁ represents the known percentage of known malicious samples (this value is known because the number of malicious samples in the total number of samples is known, and π₂ represents the unknown percentage of unknown malicious samples in the data stream.

The prompt classifier training pipeline 202 can be modified to train the prompt classifier 106 to include supervised fine-tuning and/or continual learning. For supervised fine-tuning, the prompt classifier 106 can be fine-tuned using the known malicious data and the unlabeled data. In the continual learning approach, the prompt classifier 106 is incrementally retrained rather than starting the training of a new model.

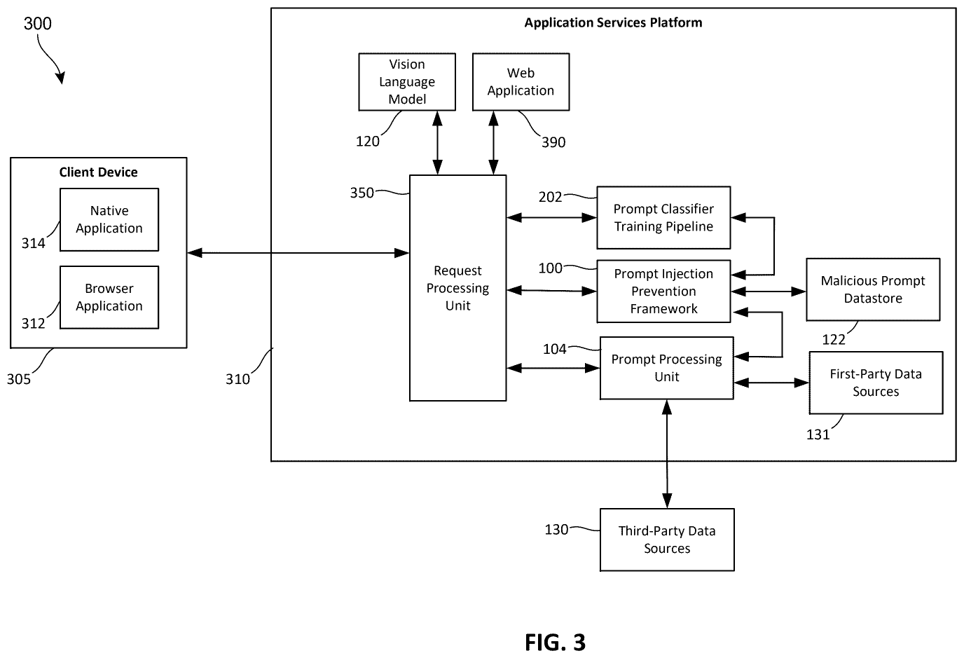

FIG. 3 is a diagram of an example computing environment 300 in which the techniques described herein are implemented. The example computing environment 300 includes a client device 305 and an application services platform 310. The application services platform 310 provides one or more cloud-based applications and/or provides services to support one or more web-enabled native applications on the client device 305. These applications may include but are not limited to design applications, communications platforms, visualization tools, and collaboration tools for collaboratively creating visual representations of information, and other applications for consuming and/or creating electronic content. The client device 305 and the application services platform 310 communicate with each other over a network (not shown). The network may be a combination of one or more public and/or private networks and may be implemented at least in part by the Internet.

The request processing unit 350 receives requests from one or more applications, such as the application 120 discussed in the preceding examples. The application services platform 310 can support multiple applications that utilize the services of the vision language model 110, and the prompt classifier 106 can analyze the prompts from these multiple applications. These applications may be implemented by the native application 314 of the client device 305 and/or the web application 390 of the application services platform 310. The native application 314 and/or the web application 390 provide a user interface that enables users to input prompts that includes a natural language prompt providing instructions to the vision language model 110 perform various tasks and one or more images that can provide context for implementing these tasks. The request processing unit 350 also coordinates communication and exchange of data among components of the application services platform 310. The application services platform also implements the vision language model 110, the prompt classifier training pipeline 202, the prompt classifier 106, and the one or more first party data sources 131 discussed in the preceding examples. The application services platform 310 also communicates over a network connection with the one or more third-party data sources 130. The prompt injection prevention framework 100 analyzes the user prompts to determine whether the prompts are malicious or benign and prevents user prompts that are determined to be malicious from being submitted to the vision language model 110.

The client device 305 is a computing device that may be implemented as a portable electronic device, such as a mobile phone, a tablet computer, a laptop computer, a portable digital assistant device, a portable game console, and/or other such devices in some implementations. The client device 305 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 3 includes a single client device, other implementations may include a different number of client devices that utilize service provided by the application services platform 310.

The client device 305 includes a native application 314 and a browser application 312. The native application 314 is a web-enabled native application, in some implementations, that enables users to view, create, and/or modify electronic content. The web-enabled native application utilizes services provided by the application services platform 310 including but not limited to creating, viewing, and/or modifying various types of electronic content. In other implementations, the browser application 312 is used for accessing and viewing web-based content provided by the application services platform 310. In such implementations, the application services platform 310 implements one or more web applications, such as the web application 390, that enables users to view, create, and/or modify electronic content and to obtain template recommendations for creating and/or modifying the electronic content. The native application 314 and/or the web application 390 can provide a user interface or users interfaces that enable the user to interact with the vision language model 110 according to the various techniques disclosed herein. The application services platform 310 supports both web-enabled native applications and a web application in some implementations, and the users may choose which approach best suits their needs.

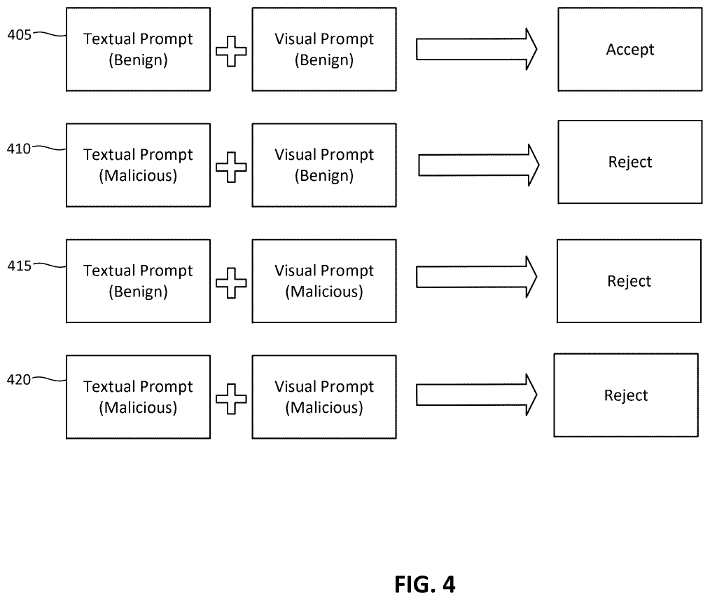

FIG. 4 shows examples of the benign and malicious user prompts that may be input by users of the application 120. User prompt 405 includes a benign textual prompt element and a benign visual prompt element. The prompt classifier 106 determines that the user prompt 405 is benign and accepts the prompt for submission to the vision language model 110.

The user prompt 410 includes a malicious textual prompt and a benign visual prompt. The malicious textual prompt may be a jailbreak prompt that injects instructions into an otherwise benign the user prompt to cause the vision language model 110 to generate content that is prohibited or otherwise cause the vision language model 110 to perform actions that would otherwise be prohibited. The visual prompt in this instance is benign and does not include any malicious content that can cause the vision language model 110 to generate content that is prohibited or otherwise cause the vision language model 110 to perform actions that would otherwise be prohibited. The prompt classifier 106 detects that the prompt is malicious and reject the prompt. The malicious prompt unit 112 of the prompt injection prevention framework 100 performs one or more actions in response to the prompt classifier 106 detecting the malicious prompt and the prompt is not submitted to the vision language model 110.

The user prompt 415 includes a benign textual prompt and a malicious visual prompt. In this instance, the textual prompt element of the user prompt is not an attempt to jailbreak the vision language model 110 or otherwise override protections that prevent the vision language model 110 from generating certain types of potentially offensive or malicious content or reveal information about the state of the model that should not be disclosed to users. However, the visual prompt element includes a meta-instruction that is included in the visual prompt element that can cause the vision language model 110 to jailbreak the vision language model 110. The meta-instruction may be added by the user submitting the prompt or may be added by a third-party, such as in third-party content used to support a retrieval framework that utilizes third-party content to supplement user prompts. The meta-instruction may be visible in the visual content, such as text included in an image, or may be hidden or embedded in the visual content so that the meta-instruction may not be visible in the content. The prompt classifier 106 detects that the prompt is malicious and reject the prompt. The malicious prompt unit 112 of the prompt injection prevention framework 100 performs one or more actions in response to the prompt classifier 106 detecting the malicious prompt and the prompt is not submitted to the vision language model 110.

The user prompt 420 includes a malicious textual prompt and a malicious visual prompt. In this instance, both the textual prompt and the visual prompt elements include malicious elements. The textual prompt may include instructions that attempt to jailbreak the vision language model 110, and the visual prompt elements may include content that include meta-instructions that are include in the visual content. As indicated above, these meta-instructions may be visible to the user or hidden within the visual content. The meta-instructions may have been introduced by the user or added by a third-party and included in third-party content included in the prompt. The prompt classifier 106 detects that the prompt is malicious and reject the prompt. The malicious prompt unit 112 of the prompt injection prevention framework 100 performs one or more actions in response to the prompt classifier 106 detecting the malicious prompt and the prompt is not submitted to the vision language model 110.

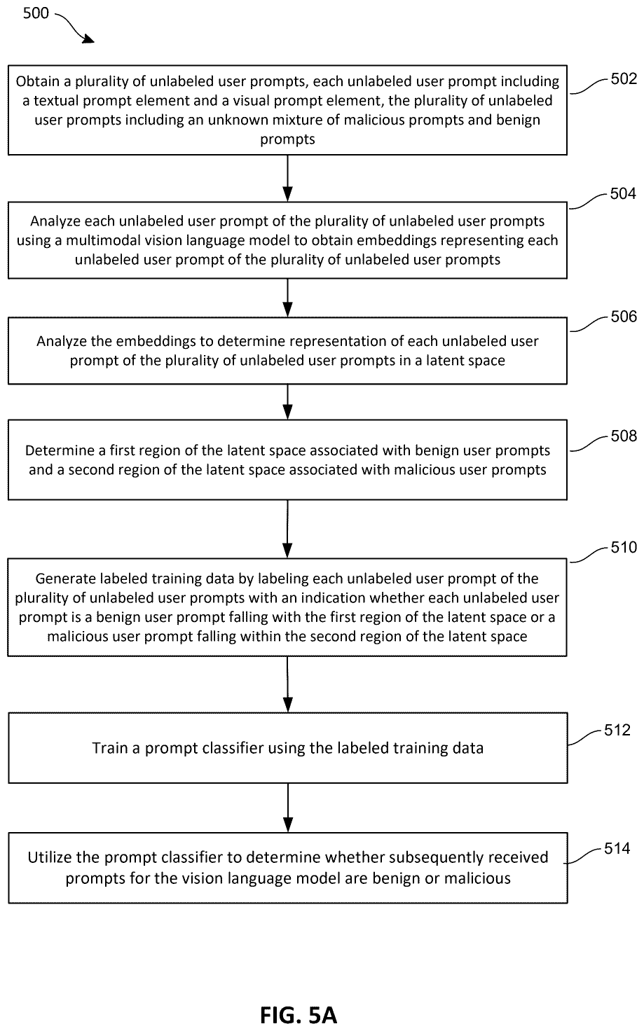

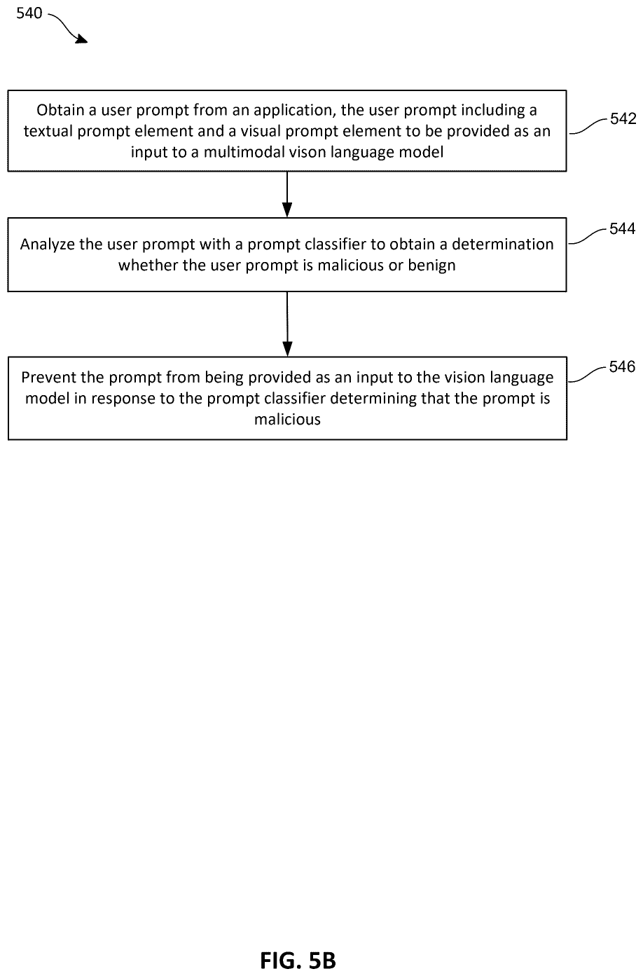

FIG. 5A is a flow chart of example process 500 for training a prompt classifier according to the techniques disclosed herein. The process 500 can be implemented by the prompt classifier training pipeline 202 as discussed in the preceding examples. FIG. 2A shows an example of the prompt classifier training pipeline 202 that can be used to train the prompt classifier 106 used to analyze prompts and output an indication whether a multimodal prompt is antagonistic. As discussed in the preceding examples, the prompt classifier training pipeline 202 can identify and prevent both direct prompt injection attacks and indirect prompt injection attacks.

The process 500 includes an operation 502 of obtaining a plurality of unlabeled user prompts, each unlabeled user prompt including a textual prompt element and a visual prompt element, the plurality of unlabeled user prompts including an unknown mixture of malicious prompts and benign prompts. The prompt selection unit 204 of the prompt classifier training pipeline 202 can sample the unlabeled user prompts from the unlabeled sample prompts datastore 216.

The process 500 includes an operation 504 of analyzing each unlabeled user prompt of the plurality of unlabeled user prompts using a multimodal vision language model to obtain embeddings representing each unlabeled user prompt of the plurality of unlabeled user prompts. The prompt processing unit 206 provides each of the unlabeled user prompts as an input to the vision language model 110 and extracts embeddings from the vision language model 110 as discussed in the preceding examples.

The process 500 includes an operation 506 of analyzing the embeddings to determine representation of each unlabeled user prompt of the plurality of unlabeled user prompts in a latent space, and an operation 508 of determining a first region of the latent space associated with benign user prompts and a second region of the latent space associated with malicious user prompts. As discussed in the preceding examples, the benign user prompts tend to fall within a first region of the latent space while the malicious user prompts tend to fall within a second region of the latent space that is separate from the first region. This difference can be used to determine a maliciousness estimation score for a user prompt based on where the user prompt maps within the latent space.

The process 500 includes an operation 510 of generating labeled training data by labeling each unlabeled user prompt of the plurality of unlabeled user prompts with an indication whether each unlabeled user prompt is a benign user prompt falling with the first region of the latent space or a malicious user prompt falling within the second region of the latent space. The maliciousness estimation unit 210 outputs the user prompt and the maliciousness estimation score associated with the user prompt as the classifier training data 212.

The process 500 includes an operation 512 of training a prompt classifier using the labeled training data. The classifier training unit 214 trains the prompt classifier 106 using the classifier training data 212 as discussed in the preceding examples.

The process 500 includes an operation 514 of utilizing the prompt classifier to determine whether subsequently received prompts for the multimodal vision language model are benign or malicious. The prompt classifier 106, once trained, can then be used to analyze prompts received from the application 120 and/or other applications to determine whether the user prompts are benign or malicious so that the application services platform 310 can prevent malicious user prompts from being provided as an input to the vision language model 110.

FIG. 5B is a flow chart of an example process 540 for detecting prompt injection according to the techniques disclosed herein. The process 540 can be implemented by the prompt injection prevention framework 100 as discussed in the preceding examples. FIG. 1B shows an example of the prompt injection prevention framework 100 that analyzes prompts to be submitted to a multimodal generative model, such as the vision language model 110, to identify and prevent prompt injection attacks on the model. As discussed in the preceding examples, the prompt classifier training pipeline 202 can identify and prevent both direct prompt injection attacks and indirect prompt injection attacks.

The process 540 includes an operation 542 of obtaining a user prompt from an application 120, the user prompt comprising a textual prompt element and a visual prompt element. The textual prompt element includes instructions to the vision language model 110 to generate content. The visual prompt element may be an image that provide context to the vision language model 110 when performing the requested instructions. As discussed in the preceding examples, the textual prompt element and/or the visual prompt element may be malicious. The visual prompt element may be obtained from a third-party data source in response to a textual prompt from a user. For instance, the textual user prompt may be submitted to an retrieval framework and the textual prompt is supplemented by visual content from one or more third-party data sources 130. This supplemental visual content is provided as an input to the vision language model 110 in such implementations.

The process 540 includes an operation 544 of analyzing the user prompt with a prompt classifier 106 to obtain a determination whether the user prompt is malicious or benign. The prompt classifier 106 is trained using unlabeled sample user prompts that include both benign and malicious prompts that have been analyzed to determine a maliciousness estimation score for each of the samples. The maliciousness estimation score differentiates between malicious and benign prompts. The prompt classifier 106 outputs an indication whether or not the prompt is predicted to be malicious based on this maliciousness estimation score.

The process 540 includes an operation 546 of preventing the prompt from being provided as an input to the vision language model 110 in response to the prompt classifier 106 determining that the prompt is malicious. The malicious prompt unit 112 can perform various actions in response to the prompt classifier 106 determining that the prompt is malicious. Otherwise, the prompt can be provided as in input to the vision language model 110.

The detailed examples of systems, devices, and techniques described in connection with FIGS. 1A-5B are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1A-5B are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

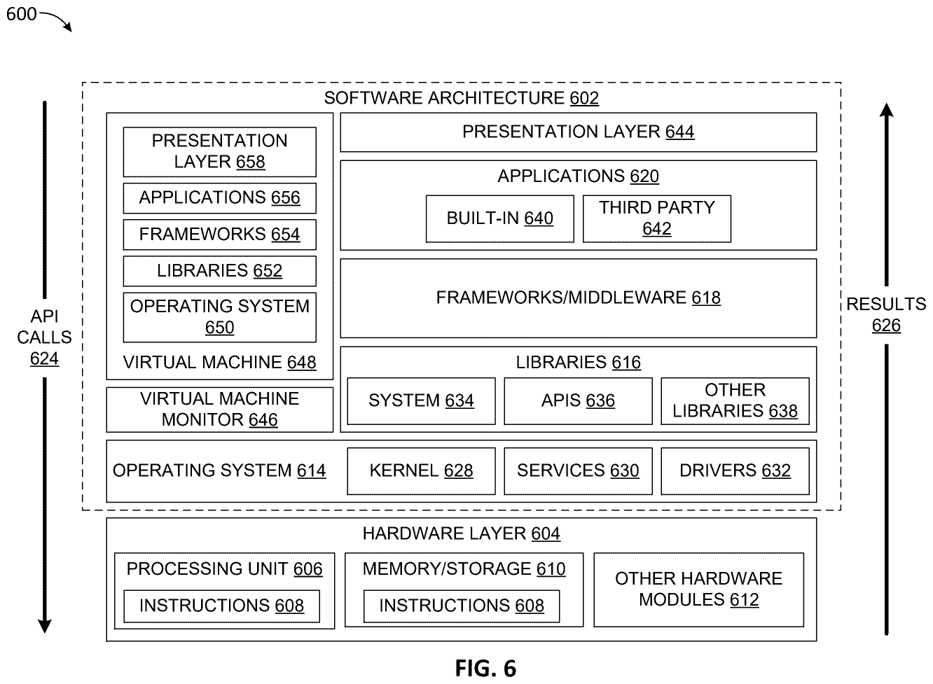

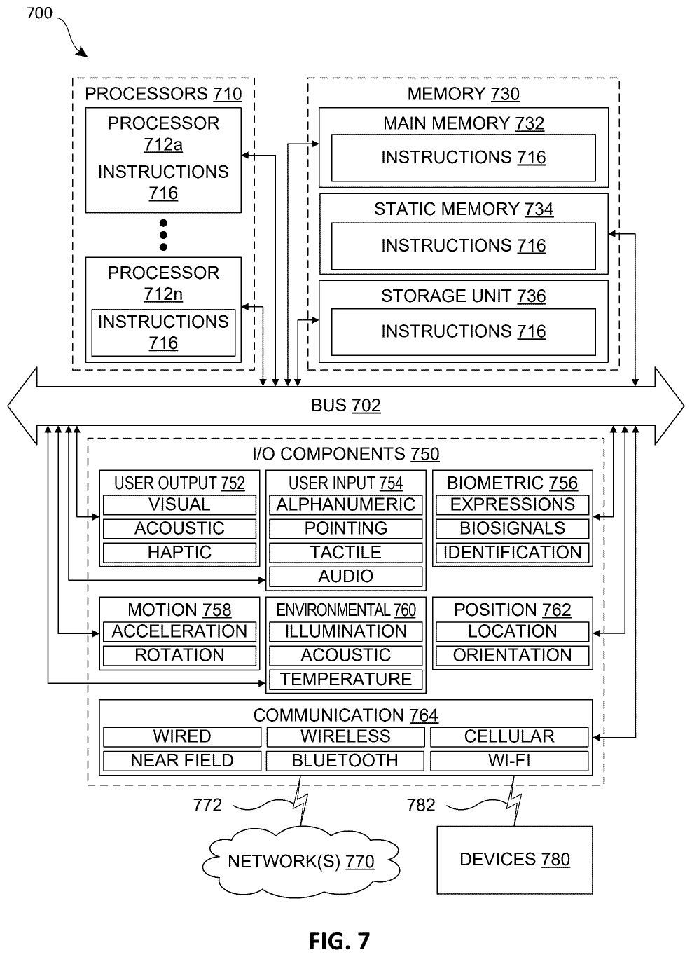

FIG. 6 is a block diagram 600 illustrating an example software architecture 602, various portions of which may be used in conjunction with various hardware architectures herein described, which may implement any of the above-described features. FIG. 6 is a non-limiting example of a software architecture, and it will be appreciated that many other architectures may be implemented to facilitate the functionality described herein. The software architecture 602 may execute on hardware such as a machine 700 of FIG. 7 that includes, among other things, processors 710, memory/storage, and input/output (I/O) components 750. A representative hardware layer 604 is illustrated and can represent, for example, the machine 700 of FIG. 7. The representative hardware layer 604 includes a processing unit 606 and associated executable instructions 608. The executable instructions 608 represent executable instructions of the software architecture 602, including implementation of the methods, modules and so forth described herein. The hardware layer 604 also includes a memory/storage 610, which also includes the executable instructions 608 and accompanying data. The hardware layer 604 may also include other hardware modules 612. Instructions 608 held by processing unit 606 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks/middleware 618, applications 620, and a presentation layer 644. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks/middleware 618 provide a higher-level common infrastructure that may be used by the applications 620 and/or other software modules. For example, the frameworks/middleware 618 may provide various graphic user interface (GUI) functions, high-level resource management, or high-level location services. The frameworks/middleware 618 may provide a broad spectrum of other APIs for applications 620 and/or other software modules.

The applications 620 include built-in applications 640 and/or third-party applications 642. Examples of built-in applications 640 may include, but are not limited to, a contacts application, a browser application, a location application, a media application, a messaging application, and/or a game application. Third-party applications 642 may include any applications developed by an entity other than the vendor of the particular platform. The applications 620 may use functions available via OS 614, libraries 616, frameworks/middleware 618, and presentation layer 644 to create user interfaces to interact with users.

Some software architectures use virtual machines, as illustrated by a virtual machine 648. The virtual machine 648 provides an execution environment where applications/modules can execute as if they were executing on a hardware machine (such as the machine 700 of FIG. 7, for example). The virtual machine 648 may be hosted by a host OS (for example, OS 614) or hypervisor, and may have a virtual machine monitor 646 which manages operation of the virtual machine 648 and interoperation with the host operating system. A software architecture, which may be different from software architecture 602 outside of the virtual machine, executes within the virtual machine 648 such as an OS 650, libraries 652, frameworks 654, applications 656, and/or a presentation layer 658.

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement modules or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory/storage 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multicore processor including cores that may execute instructions contemporaneously. Although FIG. 7 shows multiple processors, the machine 700 may include a single processor with a single core, a single processor with multiple cores (for example, a multicore processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756, motion components 758, environmental components 760, and/or position components 762, among a wide array of other physical sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 758 may include, for example, acceleration sensors (for example, an accelerometer) and rotation sensors (for example, a gyroscope). The environmental components 760 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 762 may include, for example, location sensors (for example, a Global Position System (GPS) receiver), altitude sensors (for example, an air pressure sensor from which altitude may be derived), and/or orientation sensors (for example, magnetometers).

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 764 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 764, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory storing executable instructions that, when executed, cause the processor alone or in combination with other processors to perform operations of:
obtaining a plurality of unlabeled user prompts, each unlabeled user prompt including a textual prompt element and a visual prompt element, the plurality of unlabeled user prompts including an unknown mixture of malicious prompts and benign prompts;
analyzing each unlabeled user prompt of the plurality of unlabeled user prompts using a multimodal vision language model to obtain embeddings representing each unlabeled user prompt of the plurality of unlabeled user prompts;
analyzing the embeddings to determine representation of each unlabeled user prompt of the plurality of unlabeled user prompts in a latent space;
determining a first region of the latent space associated with benign user prompts and a second region of the latent space associated with malicious user prompts;
generating labeled training data by labeling each unlabeled user prompt of the plurality of unlabeled user prompts with an indication whether each unlabeled user prompt is a benign user prompt falling with the first region of the latent space or a malicious user prompt falling within the second region of the latent space;
training a prompt classifier using the labeled training data; and
utilizing the prompt classifier to determine whether subsequently received prompts for the multimodal vision language model are benign or malicious.

2. The data processing system of claim 1, wherein analyzing each unlabeled user prompt of the plurality of unlabeled user prompts further comprises:
tokenizing the textual prompt element and the visual prompt element of each unlabeled user prompt to generate a tokenized input stream using a tokenizer of the multimodal vision language model; and
generating embedding vectors for the tokenized input stream of the textual prompt element and the visual prompt element of each unlabeled user prompt.

3. The data processing system of claim 2, wherein determining the first region of the latent space associated with benign user prompts and the second region of the latent space associated with malicious user prompts further comprises:
performing a singular vector decomposition of the embeddings for each unlabeled user prompt to generate a reduced dimensionality representation of the embeddings; and
analyzing the reduced dimensionality representation of the embeddings to determine whether each user prompt falls within the first region or the second region.

4. The data processing system of claim 1, wherein the malicious prompts include a textual prompt, visual prompt, or both the textual prompt and the visual prompt attempts to cause the multimodal vision language model to generate prohibited output or perform prohibited actions.

5. The data processing system of claim 1, wherein the multimodal vision language model is a language model that provides an application programming interface for accessing the embeddings of the multimodal vision language model.

6. The data processing system of claim 1, wherein the multimodal vision language model is selected from among a Large Language and Vision Assistant (LLaVA) model, a Phi-3-vision model, Ph-4, Phi-5 or a multimodal Pixtral model.

7. The data processing system of claim 1, wherein utilizing the prompt classifier to determine whether the subsequently received prompts for the multimodal vision language model are benign or malicious further comprises:
operating a retrieval-augmented framework in which the subsequently received prompts are supplemented with additional content from one or more first party data sources, third party data sources, or both; and
analyzing the additional content with the prompt classifier to determine whether the additional content is benign or malicious.

8. A method implemented in a data processing system for guarding against malicious prompt attacks, the method comprising:
obtaining a plurality of unlabeled user prompts, each unlabeled user prompt including a textual prompt element and a visual prompt element, the plurality of unlabeled user prompts including an unknown mixture of malicious prompts and benign prompts;
analyzing each unlabeled user prompt of the plurality of unlabeled user prompts using a multimodal vision language model to obtain embeddings representing each unlabeled user prompt of the plurality of unlabeled user prompts;
analyzing the embeddings to determine representation of each unlabeled user prompt of the plurality of unlabeled user prompts in a latent space;
determining a first region of the latent space associated with benign user prompts and a second region of the latent space associated with malicious user prompts;
generating labeled training data by labeling each unlabeled user prompt of the plurality of unlabeled user prompts with an indication whether each unlabeled user prompt is a benign user prompt falling with the first region of the latent space or a malicious user prompt falling within the second region of the latent space;
training a prompt classifier using the labeled training data; and
utilizing the prompt classifier to determine whether subsequently received prompts for the multimodal vision language model are benign or malicious.

9. The method of claim 8, wherein analyzing each unlabeled user prompt of the plurality of unlabeled user prompts further comprises:
tokenizing the textual prompt element and the visual prompt element of each unlabeled user prompt to generate a tokenized input stream using a tokenizer of the multimodal vision language model; and
generating embedding vectors for the tokenized input stream of the textual prompt element and the visual prompt element of each unlabeled user prompt.

10. The method of claim 9, wherein determining the first region of the latent space associated with benign user prompts and the second region of the latent space associated with malicious user prompts further comprises:
performing a singular vector decomposition of the embeddings for each unlabeled user prompt to generate a reduced dimensionality representation of the embeddings; and
analyzing the reduced dimensionality representation of the embeddings to determine whether each user prompt falls within the first region or the second region.

11. The method of claim 8, wherein the malicious prompts include a textual prompt, visual prompt, or both the textual prompt and the visual prompt attempts to cause the multimodal vision language model to generate prohibited output or perform prohibited actions.

12. The method of claim 8, wherein the multimodal vision language model is a language model that provides an application programming interface for accessing the embeddings of the multimodal vision language model.

13. The method of claim 8, wherein the multimodal vision language model is selected from among a Large Language and Vision Assistant (LLaVA) model, a Phi-3-vision model, Ph-4, Phi-5 or a multimodal Pixtral model.

14. The method of claim 8, wherein utilizing the prompt classifier to determine whether the subsequently received prompts for the multimodal vision language model are benign or malicious further comprises:
operating a retrieval-augmented framework in which the subsequently received prompts are supplemented with additional content from one or more first party data sources, third party data sources, or both; and
analyzing the additional content with the prompt classifier to determine whether the additional content is benign or malicious.

15. A data processing system comprising:
a processor; and
a memory storing executable instructions that, when executed, cause the processor alone or in combination with other processors to perform operations of:
obtaining a user prompt from an application, the user prompt comprising a textual prompt element and a visual prompt element for a multimodal vision language model;
analyzing the user prompt with a prompt classifier to obtain a determination whether the user prompt is malicious or benign, the prompt classifier being trained using unlabeled sample user prompts that include both benign and malicious prompts that have been analyzed to determine a maliciousness estimation score for each sample user prompt; and
preventing the user prompt from being provided as an input to the multimodal vision language model in response to the prompt classifier determining that the user prompt is malicious.

16. The data processing system of claim 15, wherein the memory further stores executable instructions that, when executed, cause the processor alone or in combination with other processors to perform operations of:
generating training data to train the prompt classifier; and
training the prompt classifier using the training data.

17. The data processing system of claim 16, wherein generating the training data to train the prompt classifier further comprises:
obtaining a plurality of unlabeled user prompts, each unlabeled user prompt including a textual prompt element and a visual prompt element, the plurality of unlabeled user prompts including an unknown mixture of malicious prompts and benign prompts;
analyzing each unlabeled user prompt of the plurality of unlabeled user prompts using a multimodal vision language model to obtain embeddings representing each unlabeled user prompt of the plurality of unlabeled user prompts;
analyzing the embeddings to determine representation of each unlabeled user prompt of the plurality of unlabeled user prompts in a latent space;
determining a first region of the latent space associated with benign user prompts and a second region of the latent space associated with malicious user prompts;
generating labeled training data by labeling each unlabeled user prompt of the plurality of unlabeled user prompts with an indication whether each unlabeled user prompt is a benign user prompt falling with the first region of the latent space or a malicious user prompt falling within the second region of the latent space; and
training the prompt classifier using the labeled training data.

18. The data processing system of claim 17, wherein determining the first region of the latent space associated with benign user prompts and the second region of the latent space associated with malicious user prompts further comprises:
performing a singular vector decomposition of the embeddings for each unlabeled user prompt to generate a reduced dimensionality representation of the embeddings; and
analyzing the reduced dimensionality representation of the embeddings to determine whether each user prompt falls within the first region or the second region.

19. The data processing system of claim 17, wherein the malicious prompts include a textual prompt, visual prompt, or both the textual prompt and the visual prompt attempts to cause the multimodal vision language model to generate prohibited output or perform prohibited actions.

20. The data processing system of claim 15, wherein the multimodal vision language model is a language model that provides an application programming interface for accessing embeddings of the multimodal vision language model.
